(19) United States
(12) Patent Application Publication
(10) Pub. No.: US 2025/0111231 A1
(43) Pub. Date: Apr. 3, 2025

(54) PRUNING OF TECHNOLOGY-MAPPED MACHINE LEARNING-RELATED CIRCUITS AT BIT-LEVEL GRANULARITY

(71) Applicant: XILINX, INC., San Jose, CA (US)

(72) Inventors: Linus Matthias WITSCHEN, Dublin (IE); Michaela BLOTT, Dublin (IE); Nicholas FRASER, Co. Dublin (IE); Thomas Bernd PREUSSER, Dresden (DE); Yaman UMUROGLU, Stockholm (SE)

(21) Appl. No.: 18/374,642

(22) Filed: Sep. 28, 2023

(51) Int. Cl. G06N 3/082

(52) U.S. Cl. CPC G06N 3/082

(57) ABSTRACT

Embodiments herein describe pruning of technology-mapped machine learning-related circuits at bit-level granularity, including techniques to efficiently remove look-up tables (LUTs) of a technology-mapped netlist while maintaining a baseline accuracy of an underlying machine learning model. In an embodiment, a LUT output of a current circuit design is replaced with a constant value, and at least the LUT and LUTs within a maximum fanout-free cone (MFFC) are removed, to provide an optimized circuit design. The current circuit design or the optimized circuit design is selected as a solution based on corresponding training data-based accuracies and metrics (e.g., LUT utilization), and optimization criteria. If the optimized circuit design is rejected, inputs to the LUT may be evaluated for pruning. A set of solutions may be evaluated based on validation data-based accuracies and metrics of the corresponding circuit design. Solutions that do not meet a baseline accuracy may be discarded.

### TECHNICAL FIELD

Examples of the present disclosure generally relate to pruning of technology-mapped machine learning-related circuits at bit-level granularity.

### BACKGROUND

Machine learning is used in a variety of applications, such as computer vision. A circuit may be designed or configured to implement a trained machine learning model. For example, a trained machine learning model can be transformed into Boolean expressions that can be implemented with look-up tables (LUTs) in a circuit. Such a circuit may be complex in terms of numbers of components and interconnections, and thus expensive to design and fabricate.

### SUMMARY

Techniques for pruning of technology-mapped machine learning-related circuits at bit-level granularity are described. One example is a method that includes pruning look-up tables (LUTs) of a network of LUTs of a current circuit design, at a bit-level, to provide an optimized circuit design, and selecting one of the current circuit design and the optimized circuit design as a circuit design solution based on measures of accuracy and metrics of the corresponding circuit designs.

Another example described herein is an apparatus that includes a processor and memory that replaces a LUT of the current circuit design with a constant logic state to provide a revised circuit design, optimizes LUT usage of the revised circuit design to provide an optimized circuit design, and selects one of the current circuit design and the optimized circuit design as the circuit design solution based on measures of accuracies and metrics of the corresponding circuit designs, where the current circuit design and the optimized circuit design are technology-mapped circuit designs.

Another example described herein is a non-transitory computer readable medium having a computer program that includes instructions to cause a processor to prune a look-up table (LUT) of a network of LUTs of a current circuit design, at a bit-level, to provide an optimized circuit design, select one of the current circuit design and the optimized circuit design as a circuit design solution based on training data-based accuracies and metrics of the corresponding circuit designs, and evaluate a set of circuit design solutions that includes the circuit design solution, to identify one of the circuit design solutions as an output solution based on validation data-based accuracies and metrics of the corresponding circuit designs and an optimization criterion, where the current circuit design and the optimized circuit design are technology-mapped circuit designs, the network of LUTs represents a trained artificial neural network, the training data-based accuracies are based on training data used to train the artificial neural network, and the validation data-based accuracies are based on validation data used to validate the artificial neural network.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a directed acrylic graph (DAG) of a LUT network, according to an embodiment.

FIG. 2 is a block diagram of a electronic design automation (EDA) platform, according to an embodiment.

FIG. 3 is a block diagram of a bit-level pruning tool of the EDA platform, according to an embodiment.

FIG. 4 illustrates pseudo-code for bit-level pruning a technology-mapped circuit design, according to an embodiment.

FIG. 5 is a conceptual illustration of bit-level pruning for a Layerᵢ of a LUT network, according to an embodiment.

FIG. 6 is a flowchart of a method of bit-level pruning a technology-mapped circuit design, according to an embodiment.

FIG. 7 illustrates pseudo-code for bit-level pruning, according to an embodiment.

FIG. 8 illustrates a flowchart of a method of optimizing bit-level prunings, according to an embodiment.

FIG. 9 illustrates a flowchart of a method of post-processing bit-level prunings, according to an embodiment.

FIG. 10 is a block diagram of configurable circuitry, including an array of configurable or programmable circuit blocks or tiles, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe pruning of technology-mapped machine learning-related circuits at bit-level granularity (i.e., bit-level pruning).

Bit-level pruning identifies elements of a circuit design that can be omitted with little or no loss of functionality/accuracy. Bit-level pruning reduces hardware components of a circuit design, which results in simplified logic, and which may reduce design, fabrication, and/or operating costs.

In an embodiment, bit-level pruning may be equivalently described as driving a connection with a constant value, and may be analogous to introducing stuck@faults in circuit testing, where a wire in the circuit is driven with a constant value.

Bit-level pruning may be applied to a variety of types of circuit components, such as look-up tables (LUTs) of a hardware implementation of a trained machine learning model. LUT-based hardware implementations of trained machine learning models may be relatively efficient and may achieve relatively high throughput with relatively low latencies.

A challenge in circuit design is meeting constraints on resource utilization to accommodate the implementation on a target hardware platform with a limited hardware resource budget, while achieving target performance criteria. During the circuit design process, an objective may include minimizing a hardware cost (e.g., LUT utilization) of the circuit design.

As disclosed herein, a circuit is pruned at bit-level granularity (e.g., LUT-level pruning). LUT-level pruning may include replacing a LUT with a constant logic state of 0 or 1. LUT pruning may further include removing LUTs within a fanout free cone of the replaced LUT (i.e., upstream LUTs that are rendered dangling/obsolete by the replacing), and/or optimizing (e.g., consolidating) LUTs downstream of the replaced LUT. In an embodiment, bit-level pruning is performed on a technology-mapped netlist of a circuit design by pruning connections between LUTs. and driving the connections with constant values or logic state. Bit-level pruning may provide immediately hardware savings, and may permit immediate evaluation of the resulting LUT utilization.

Bit-level pruning may be performed as part of a circuit optimization process, alone and/or in combination with other optimization techniques that prune at a higher level of abstraction (e.g., arithmetic level pruning that focuses on arithmetic components based on estimated error and/or switching activity). Effects/benefits of LUT reductions obtained by bit-level pruning are immediate, as the changes are implemented in the technology-mapped netlist, which permits immediate evaluation of the resulting LUT utilization, as in contrast to pruning abstract data structures, where improvements may be compromised throughout the synthesis process.

Bit-level pruning may decrease complexity of a circuit design beyond what is achievable with pruning at a higher level of abstraction, with little or no accuracy loss. Bit-level pruning may, for example, identify over-provisioned components that are unnoticed or undetectable at the higher-level of abstraction, which results in additional LUT reductions. In some situations, eliminating over-provisioned components may increase accuracy.

Bit-level pruning is described below with respect to look-up table (LUT) based hardware implementations of machine learning applications, including examples in which a neural network is implemented on a field-programmable gate array (FPGA). As the cost of truth table enumeration and hardware implementation grows with the neuron fan-in, such a circuit may use a topology that combines high sparsity and low-precision activation quantization to implement the machine learning model within a relatively small hardware budget (e.g., a FPGA die). Techniques disclosed herein are not, however, limited to FPGAs. Bit-level pruning may be applied to a circuit design that captures a machine learning model as a physical circuit.

A field-programmable gate array (FPGA) is a very large scale integrated (VLSI) circuit that includes programmable logic elements, programmable input/output elements, and programmable routing elements. A FPGA may include look-up tables (LUTs) with varying numbers of inputs. A LUT may implement a single-output Boolean function of up to k variables.

To synthesize an FPGA design, a technology-independent synthesis procedure generates a Boolean logic network for a target function. A technology mapping procedure then maps the Boolean logic network into a network of interconnected LUTs. The LUT network may be represented by a directed acyclic graph (DAG), in which nodes represent k-input LUTs which implement a Boolean function, and directed edges (vᵢ, uⱼ) represent paths between outputs of nodes vᵢ and inputs of nodes uᵢ. The incoming/outgoing edges of the nodes are referred to as fanin/fanout of the node. Nodes that connect the network to its environment and have no fanin are referred to as primary inputs (PIs). Nodes that connect the network to its environment via their fanout are referred to as primary outputs (POs). A node v may have an associated transitive fanin/fanout cone Cᵥ. The cone Cᵥ is a sub-network that includes at least node v and may contain some of the predecessor/successor nodes (i.e., upstream/downstream nodes) of node v such that, for any node w within cone Cᵥ (w∈Cᵥ), there is a path from node w to node v for the transitive fanin cone and from node v to node w in the transitive fanout cone that lies entirely in the cone Cᵥ. Node v may be referred to the root of cone Cᵥ. A fanout-free cone (FFC) is a transitive fanin cone in which all fanouts (i.e., outputs) of the nodes are within the cone (i.e., converge at root v).

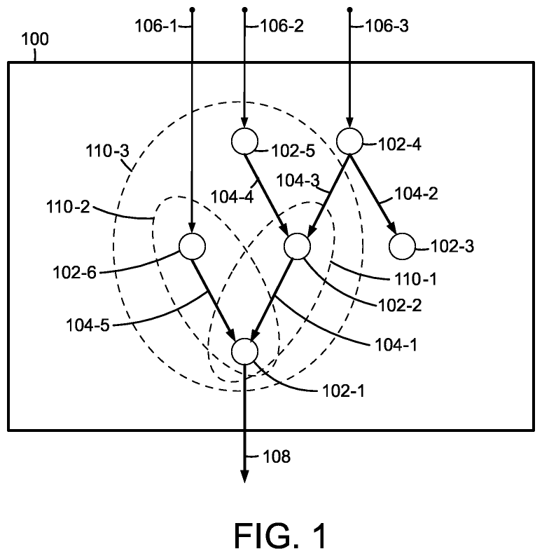

FIG. 1 illustrates a directed acrylic graph (DAG) of a LUT network 100, according to an embodiment. LUT network 100 includes nodes 102-1 through 102-6 (nodes 102), and edges 104-1 through 104-5 (edges 104). LUT network 100 receives primary inputs 106-1, 106-2, and 106-3 (inputs 106), and provides an output 108. In the example of FIG. 1, node 102-1 is a root node of three FFCs, 110-1, 110-2, and 110-3. FFC 110-1 includes node 102-2. FFC 110-2 includes node 102-6. The maximum FFC (MFFC) is the FCC 110-3. In the example of FIG. 1, FFC 110-3 encompasses or includes nodes 102-2, 102-5, and 102-6. FFC 110-3 is node 102-1's largest FFC, and thus the MFFC of node 102-1. In FIG. 1, nodes 102 correspond to Boolean functions, and may be represented with LUTs in a circuit. LUT network 100 may represent a neuron, or a portion of a neuron of an artificial neural network, and a fanout of node 102-1 may drive 108 (i.e., node 102-1 may represent a primary output bit of the neuron of the artificial neural network).

In an embodiment, bit-level pruning replaces a LUT that represents root node 102-1 (i.e., a primary output bit) with a constant logic state (i.e., 0 or 1), and discards LUTs that are rendered dangling/obsolete by the replacement (e.g., LUTs that represent nodes within the MFFC 110-3).

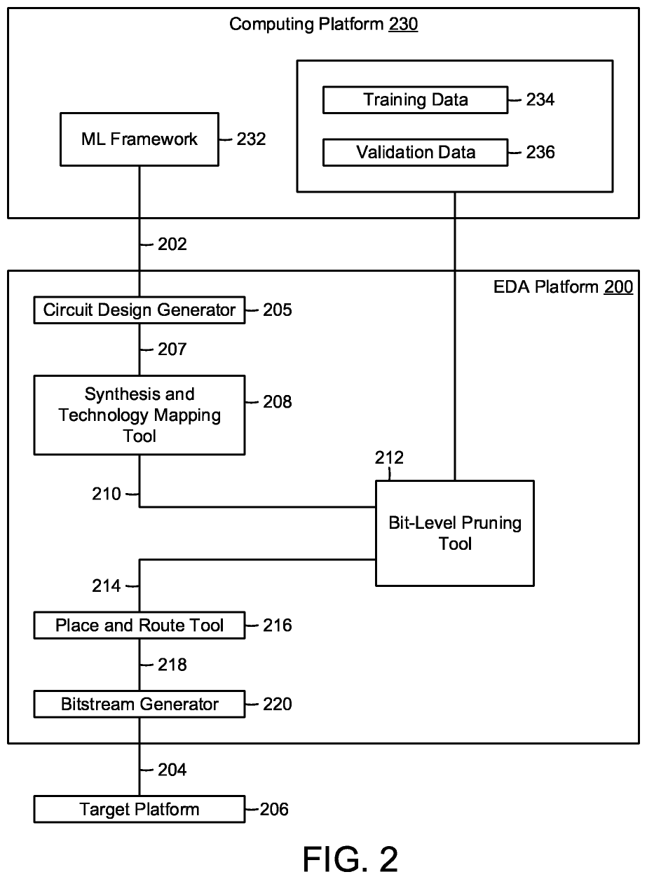

FIG. 2 is a block diagram of an electronic design automation (EDA) platform 200, that converts a trained machine learning model (ML model) 202 to a bitstream 204 for configuring look-up tables (LUTs) of a target platform 206 (e.g., an integrated circuit device, such as a FPGA), according to an embodiment. EDA platform 200 may include a processor that executes instructions from memory and/or hardware-based circuitry. EDA platform 200 may represent a single platform or multiple platforms, which may be centralized and/or distributed (e.g., cloud-based). EDA platform 200, or another computing platform 230 may include a ML framework 232 that trains ML model 202 based on training data 234. ML framework 232 may also validate ML model 202 based on validation data 236.

In the example of FIG. 2, EDA platform 200 includes a circuit design generator 205, a synthesis and technology mapping tool 208, a bit-level pruning tool 212, a place and route tool 216, and a bitstream generator 220. EDA platform 200 may include one or more additional EDA tools.

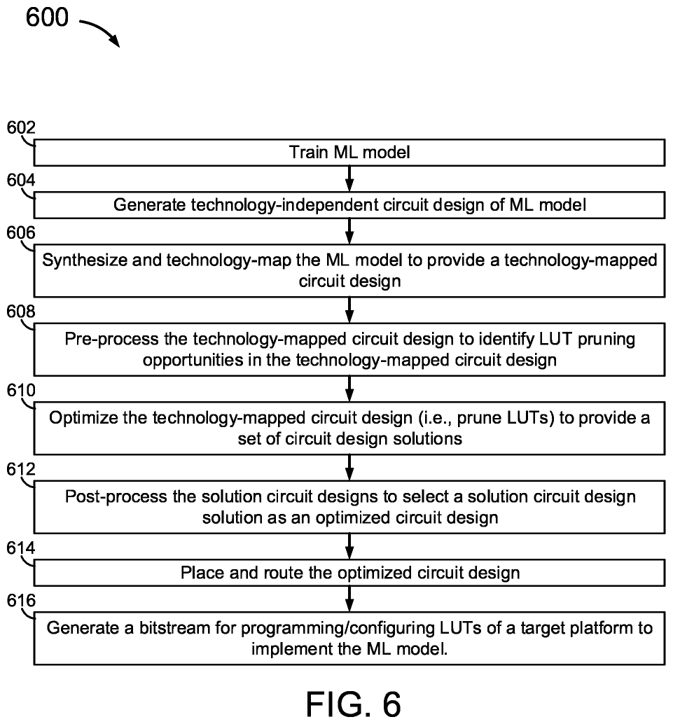

Bit-level pruning tool 212 prunes LUTs of a technology-mapped circuit design (ckt) 210 at a bit-level, and outputs an optimized (i.e., pruned) technology-mapped circuit design 214. Since bit-level pruning tool 212 receives a technology-mapped circuit design and outputs a technology-mapped circuit design, bit-level pruning tool 212 may be seamlessly integrated into existing EDA design flows, and may complement other EDA processes. Technology-mapped circuit design ckt 210 and optimized technology-mapped circuit design 214 may include technology-mapped netlists. Technology-mapped netlists are described further below with reference to 606 in FIG. 6.

As described further below, bit-level pruning tool 212 may replace a LUT of a ckt 210 with a constant logic state to provide a revised circuit design, optimize the revised circuit design (e.g., remove LUTs within a MFFC of the replaced LUT and/or consolidate LUTs in a downstream path of the replaced LUT), and evaluate the optimized revised circuit design (e.g., with respect to accuracy, LUT utilization, and/or an optimization criterion).

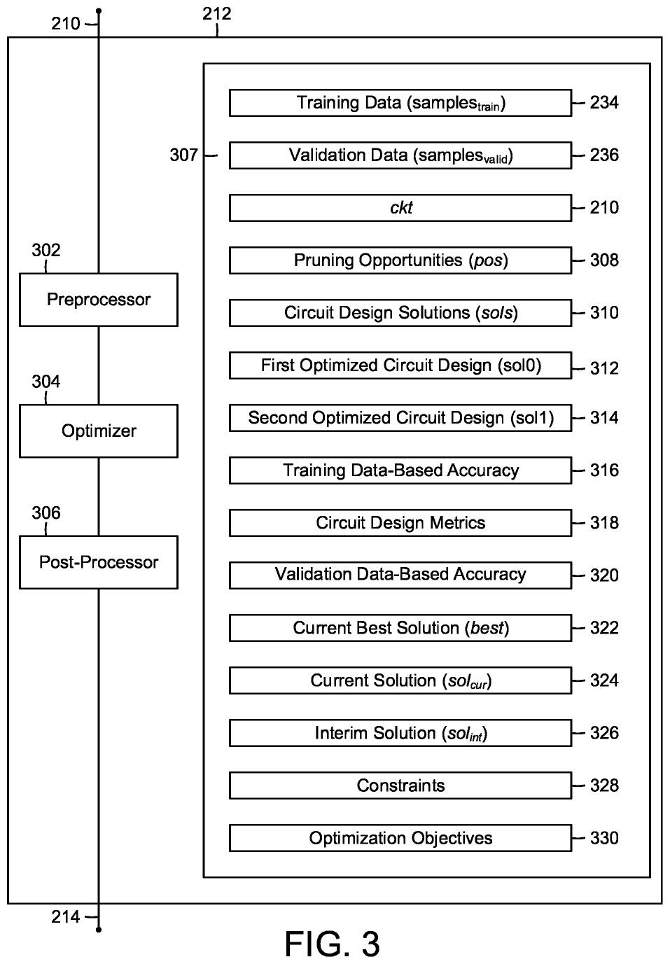

FIG. 3 is a block diagram of bit-level pruning tool 212, according to an embodiment. In the example of FIG. 3, bit-level pruning tool 212 includes a pre-processor 302, an optimizer 304, a post-processor 306, and a data storage medium 307.

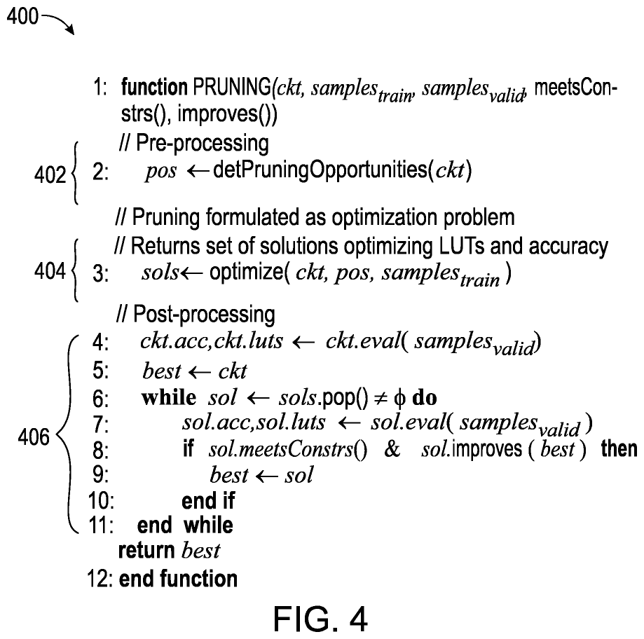

FIG. 4 illustrates pseudo-code 400 for bit-level pruning a technology-mapped circuit design, according to an embodiment. Pseudo-code 400 includes pre-processing pseudo-code 402 (line 2), optimizing pseudo-code 404 (line 3), and post-processing pseudo-code 406 (lines 4-11), which may represent example functions or implementations of pre-processor 302, optimizer 304, and post-processor 306, respectively. Pseudo-code 400 receives technology-mapped circuit design ckt 210, and returns a modified version of ckt as best (i.e., optimized technology-mapped circuit design 214). As with bit-level pruning tool 212, pseudo-code 400 may be seamlessly integrated into existing EDA design flows, and may complement other EDA processes.

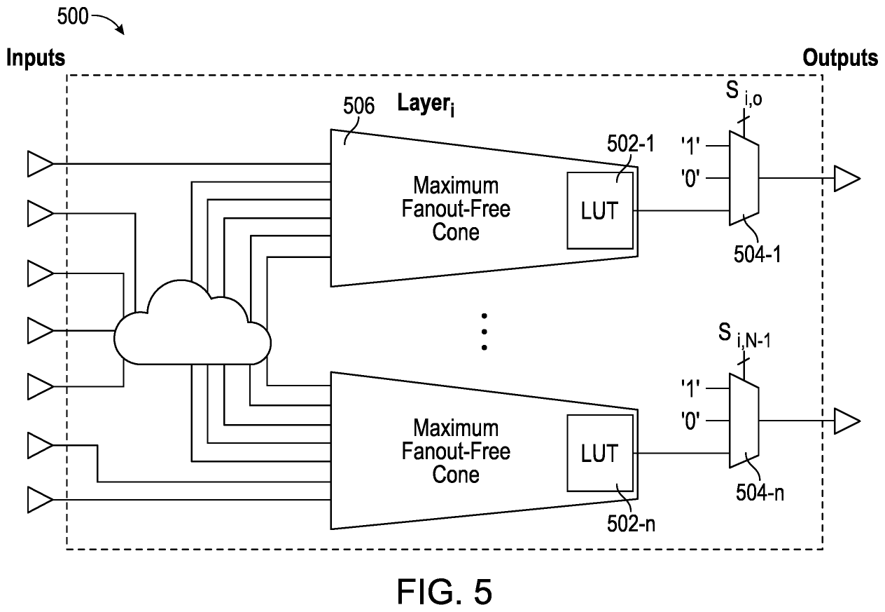

FIG. 5 is a conceptual illustration of bit-level pruning for a Layer 500 of a LUT network, according to an embodiment. Layerᵢ includes LUTs 502-1 through 502-n (collectively, LUTs 502), which may represent LUTs of ckt 210.

FIG. 6 is a flowchart of a method 600 of bit-level pruning a technology-mapped circuit design, according to an embodiment. Method 600 is described below with reference to FIGS. 1-5. Method 600 is not, however, limited to the examples of FIGS. 1-5.

At 602, ML framework 232 trains ML model 202 based on training data 234. In an embodiment, ML model 202 is, or includes an artificial neural network (NN), and ML framework 232 trains the NN based on a supervised learning technique. For example, and without limitation, training data 234 may include labeled data, and ML framework 232 may train ML model 202 to infer the labels from the data

At 604, circuit design generator 205 generates an initial circuit design 207 to implement or mimic ML model 202. Circuit design 207 may include a LUT-based hardware description of ML model 202. Circuit design 207 may include a technology-independent (i.e., platform independent) netlist of electronic components and interconnections. Circuit design generator 205 may utilize one or more of a variety of applications, such as, without limitation, LogicNets, LUTnet, and/or NullaNet.

At 606 synthesis and technology mapping tool 208 converts initial circuit design 207 to technology-mapped circuit design ckt 210 (e.g., a technology-mapped netlist). Synthesis and technology mapping tool 208 may convert circuit design 207 to technology-mapped circuit design ckt 210 based on components of a technology library (e.g., a standard-cell library) associated with target platform 206. Synthesis and technology mapping tool 208 may implement Boolean functions of circuit design 207 as a network of components chosen from the technology library, while optimizing one or more design constraints (e.g., total area and/or delay). Technology-mapped circuit design ckt 210 may include a network of interconnected LUTs that implement/mimic neurons of ML model 202.

Technology-mapped circuit design ckt 210 may include a relatively large number of LUTs (i.e., pruning opportunities). Where method 600 employs a ternary decision-based pruning process (i.e., evaluation of ckt 210 and two variations thereof), such as described further below, N LUTs provide in 3^{N} possible pruning opportunities, meaning that the design space grows exponentially. While a larger number of pruning opportunities may improve granularity (in theory, every connection and/or LUT in ckt may be subject to pruning), it may be desirable to restrain the number of pruning opportunities to bound the size of the explored design space (in some situations, such as for relatively small networks, all LUTs may be considered pruning opportunities).

At 608, pre-processor 302 pre-processes technology-mapped circuit design 210 to select or identify a subset of LUTs of ckt 210 as pruning opportunities (pos) 308. Pre-processor 302 may select pruning opportunities pos 308 based on a criterion. Pre-processor 302 may balance granularity and size of the explored design space by, for example, selecting LUTs that represent output bits of neurons of layers of ML model 202 (i.e., LUTs that produce output bits of neurons of ML model 202) as pruning opportunities pos 308. In this way, the number of pruning opportunities N may provide a desired level of granularity that allows for exploiting optimization potential through fine-grained prunings. In FIG. 4, line 2 of pseudo-code 400 calls a function detPruningOpportunities(ckt) that selects or identifies a subset of circuit elements (e.g., LUTs and connections) of ckt 210 as pruning opportunities pos 308. In FIG. 5, LUTs 502 may represent primary outputs of Layerᵢ, which pre-processor 302 and/or the function detPruningOpportunities(ckt) may select as pruning opportunities pos 308.

At 610, optimizer 304 optimizes (i.e., prunes) technology-mapped circuit design ckt 210 based on pruning opportunities pos 308 to provide circuit design solutions (sols) 310 (e.g., optimized technology-mapped netlists).

In FIG. 5, pruning is conceptually illustrated as 3-input multiplexers 504-1 through 504-n (collectively, multiplexers 504) connected to outputs of corresponding LUTs 502. Multiplexers 504 are controlled by corresponding multiplexer select signals s_{i,n}, where n∈[0, N−1]. Multiplexers 504 propagate outputs of the corresponding LUTs 502, a constant 0, or a constant 1 (i.e., a ternary pruning decision), based on multiplexer select signals Sin. Conceptually, all multiplexer select signals 506 are initially set to propagate the output of the corresponding LUTs 502, and a process changes the multiplexer select signals 506 to propagate constants and generates the output data for evaluation. The process may cycle through all LUTs 502.

In practice, optimizer 304 may replace LUT 502-1 with a logic state 0 to provide a first revised circuit design, optimize the first revised circuit design (e.g., by removing LUTs within a MFFC 506 of LUT 502-1, and/or by omitting and/or consolidating LUTs in a downstream path of LUT 502-1 based on propagation of the logic state 0), to provide a first optimized circuit design sol0 312. Optimizer 304 may further replace LUT 502-1 with a logic state 1 to provide a second revised circuit design, and optimize the second revised circuit design to provide a second optimized circuit design soil 314. First and second optimized circuit designs sol0 312 and sol1 314 are technology-mapped circuit designs (e.g., technology-mapped netlists).

Optimizer 304 may emulate and/or simulate circuit designs ckt 210, sol0 312, and soil 314 based on training data 234, and may compute training data-based accuracies 316 for circuit designs ckt 210, sol0 312, and soil 314 based on corresponding output data. For example, and without limitation, where training data 234 includes labeled data, training data-based accuracies 316 may indicate how well (e.g., a degree to which) circuit designs ckt 210, sol0 312, and soil 314 infer the labels from the data.

Optimizer 304 may compute circuit design metrics (metrics) 318 for circuit designs ckt 210, sol0 312, and soil 314. Metrics 318 may include, without limitation, metrics related to the corresponding circuit designs, hardware, area, and/or timing. As an example, and without limitation, metrics 318 may include measures of LUT utilization (e.g., based on actual numbers and/or sizes of LUTs of circuit designs ckt 210, sol0 312, and soil 314, and/or based on numbers of LUTs removed during optimization).

Optimizer 304 may select one of circuit designs ckt 210, sol0 312, and soil 314 as a circuit design solution sols 310 based on the corresponding training data-based accuracies 316, metrics 318 of circuit designs ckt 210, sol0 312, and soil, constraints 328, and optimization objectives 330. Optimization objectives 330 may include, without limitation, criteria related to circuit delay, power/energy consumption, transistor count, and/or circuit or application statistics. Optimizer 304 may select one of circuit designs ckt 210, sol0 312, and soil 314 that, for example, minimizes LUT utilization while maintaining or maximizing a baseline accuracy (e.g., a training data-based accuracy).

In an embodiment, optimization may be expressed as depicted in EQ(1):

$${maximize}_{x} \sqrt{{( 1 - \frac{x \cdot acc}{ckt \cdot acc} )}^{2} + {( 1 - \frac{x \cdot luts}{ckt \cdot luts} )}^{2}} \qquad ( 1 )$$

$$subject to \begin{matrix}x \cdot acc \geq ckt \cdot acc . \\ x \cdot luts < ckt \cdot luts\end{matrix}$$

where x represents a pruned version of ckt 210 (i.e., sol0 312 or soil 314), and y.acc and y.luts, y∈, {x, ckf}, represent a baseline accuracy (e.g., training data-based accuracy 316) and metrics 318, respectively, of the pruned circuit x or the original circuit ckt 210.

Optimizer 304 may optimize with respect to a two-dimensional objective space defined by relative changes in training data-based accuracies 316 and metrics 318, in which optimization seeks to maximize a length of a vector from an origin (i.e., training data-based accuracy 316 and metrics 318 of ckt 210) to a solution x. The coordinates of a solution x in the objective space may be illustrated by the following tuple, in which a negative relative change in training data-based accuracy reflects an improvement:

$$( 1 - \frac{x \cdot acc}{ckt \cdot acc} , 1 - \frac{x \cdot luts}{ckt \cdot luts} )$$

The formulated constraints on training data-based accuracy 316 and metrics 318 may be useful to ensure that only solutions that improve the baseline of ckt 210 (or other baseline accuracy) are considered.

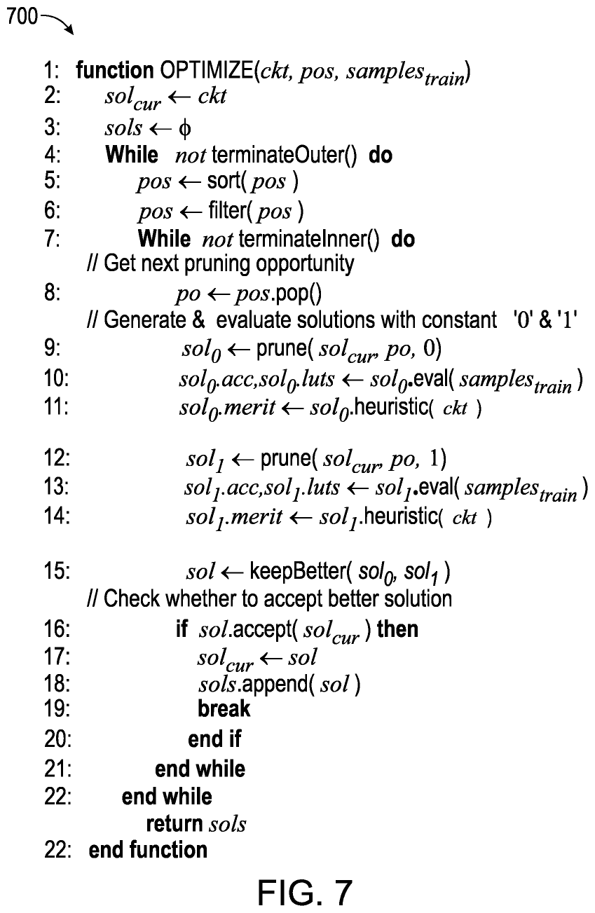

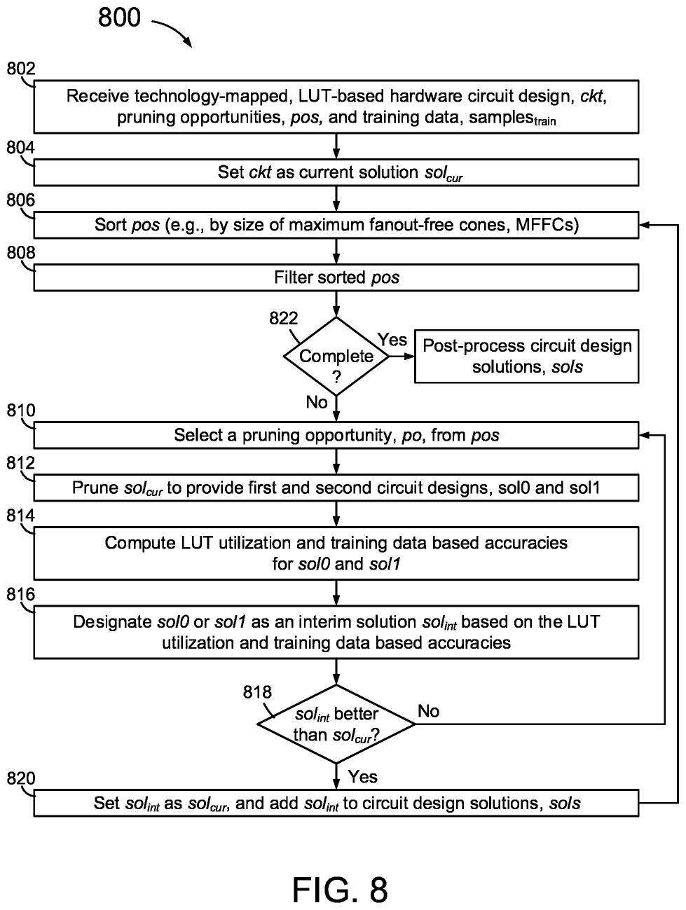

Optimizer 304 may utilize one or more of a variety of approaches to select one of circuit designs ckt 210, sol0 312, and sol1 314 as a circuit design solution in the set of circuit design solutions sols 310 such as, without limitation, a genetic algorithm (e.g., NSGA-II) and/or a heuristic search (e.g., hill climbing, simulated annealing, or best-first search). Optimizer 304 may utilize an iterative greedy approach, such as described further below with reference to FIGS. 7 and 8.

Optimizer 304 may perform the foregoing optimization processes for remaining LUTs 502 to generate additional circuit design solutions sols 310. In an embodiment, optimizer 304 sorts or orders pruning opportunities pos 308 based on a criterion, such as described further below with reference to FIGS. 7 and 8, and evaluates pruning opportunities pos 308 based on the ordering. Alternatively, optimizer 304 may evaluate pruning opportunities pos 308 in a random fashion.

In FIG. 4, pseudo-code 400, line 3, calls an optimization function optimize(ckt, pos, samplesₜᵣₐᵢₙ) that determines sols 310 based on ckt 210, pruning opportunities pos 308, and training data 234, such as described above with reference to optimizer 304.

In the example of FIG. 6, optimizer 304 provides post-processor 306 with a set of circuit design solutions sols 310 rather than a single solution. This may be useful where solutions that satisfy a constraint related to training data 234 might not satisfy a constraint related to validation data 236.

At 612, post-processor 306 selects a circuit design solution sols 310 as optimized technology-mapped circuit design 214. Post-processor 306 may select a circuit design solution from the circuit design solutions sols 310 based on validation data 236, metrics 318, and an optimization objective 330. Post-processor 306 may emulate or simulate circuit design solutions sols 310 based on validation data 236, and may compute validation data based accuracies 320 for circuit design solution sols 310 based on corresponding output data. For example, and without limitation, where validation data 236 includes labeled data, validation data-based accuracies 320 may indicate how well (e.g., a degree to which) circuit design solutions sols 310 infer the labels from the data.

In FIG. 4, pseudo-code 400, lines 4-11, implements a validation phase in which validation data-based accuracies 320 of circuit design solutions sol E sols are evaluated for unseen data, represented by samples_{valid} 236.

In FIG. 4, pseudo-code 400, lines 4-11, evaluates solutions sol E sols (i.e., sols 310) in terms of metrics 318 (sol.luts) and validation data-based accuracies 320 (sol.acc) for unseen data, which is represented by the validation set samples_{valid} (i.e., validation data 236). A function sol.improves(best) determines whether metrics 318 of a solution sol is an improvement over a current best solution, best 322. A function sol.meetsConstrs( ) determines whether the solution sol achieves a baseline accuracy of the solution ckt 210. The functions sol.meetsConstrs( ) and sol.improves(best) define constraints 328 and optimization objectives 330, respectively. Constraints 328 (e.g., maintaining a baseline accuracy of ckt 210) and optimization objectives 330, or a portion thereof, may be provided by a user.

When all circuit design solutions sols 310 have been evaluated, pseudo-code 400, line 11, returns the solution best 322 that optimizes metrics 318 (e.g., minimizes LUT utilization) and meets constraints 328 (e.g., maintains the baseline accuracy of ckt 210), as optimized technology-mapped circuit design 214.

At 614, place and route tool 216 places and routes technology-mapped circuit design 214 to provide a physical layout 218.

At 616, bitstream generator 220 converts physical layout 218 to a bitstream 204 for programming or configuring LUTs of target platform 206 to implement or mimic ML model 202.

Pre-processing at 608 may be preceded by one or more other optimization processes/techniques, which may include a LUT optimization/pruning technique at a higher level of abstraction, such as described further above. Where pre-processing at 608 is preceded by another LUT optimization technique, pre-processing at 608, optimizing at 610, and post-processing at 612 may be useful to identify and remove over-provisioned LUTs that remain after the other LUT optimization technique, and thus further reduce LUT utilization.

FIG. 7 illustrates pseudo-code 700 for bit-level pruning, according to an embodiment. Pseudo-code 700 may represent example functions or implementations of optimizer 304 in FIG. 3, optimization pseudo-code 404 (lines 3) in FIG. 4, and/or optimizing at 610 in FIG. 6. Pseudo-code 700 is described below with reference to FIG. 8.

FIG. 8 illustrates a flowchart of a method 800 of optimizing bit-level prunings, according to an embodiment.

At 802, optimizer 304 receives technology-mapped circuit design ckt 210, pruning opportunities pos 308, and training data 234.

At 804, optimizer 304 designates technology-mapped circuit design ckt 210 as a current solution sol_{cur} 324 (pseudo-code 700, line 2).

At 806, optimizer 304 order or sorts pruning opportunities pos 308 (pseudo-code 700, line 5). Optimizer 304 may sort pruning opportunities pos 308 in descending order based on sizes of MFFCs (e.g., number/sizes of LUTs within the MFFCs). MFFC is a useful sorting metric because it represents the number of LUTs that become dangling (i.e., obsolete) after pruning, and thus provides an estimate of immediate savings achieved by pruning. In addition, MFFC size may be determined relatively efficiently.

Alternatively, or additionally, optimizer 304 may sort pruning opportunities pos 308 based on sizes of transitive fanin/fanout cones or on/off-times of a bit. Alternatively, or additionally, optimizer 304 may consider a significance of a pruning opportunity pos 308 (e.g., a position of the bit in an output vector of the neuron, and/or or relations/correlations of groups of neurons as indications of impact on overall accuracy).

At 808, optimizer 304 may filter pruning opportunities pos 308 (pseudo-code 700, line 6), to discard pruning opportunities that provide little or no benefit (e.g., LUTs that have no fanout and/or LUTs that were previously rejected as pruning opportunities).

Optimizer 304 then enters an inner loop (pseudo-code 700, lines 7-21) of two nested loops to apply prunings in an iterative fashion.

At 810, optimizer 304 selects a pruning opportunity po from sorted pruning opportunities pos 308 (pseudo-code 700, line 8). Optimizer 304 may select the highest-ranked pruning opportunity (e.g., having the largest MFFC).

At 812, optimizer 304 generates first and second revised circuit designs, sol0 312 and soil 314, such as described further above with reference to 610 in FIG. 6.

At 814, optimizer 304 determines metrics 318 and training data-based accuracies 316 for sol0 312 and soil 314, such as described further above with reference to 610 in FIG. 6. Although LUT savings due to removal of dangling LUTs (e.g., LUTs within a MFFC of a replaced LUT) is the same whether a LUT is replaced with a logic state 0 or a logic state 1, optimization potentials and impacts on accuracy may differ. Thus, it may be preferable to evaluate both situations.

At 816, optimizer 304 selects circuit design sol0 312 or circuit design soil 314 (pseudo-code 700, line 15) as an interim circuit design solution solᵢₙₜ 326 (designated sol in pseudo-code 700) based on the corresponding training data-based accuracies 316 and metrics 318. Optimizer 304 may employ the heuristic from Eq. (1) and the acceptance function in line 16 of pseudo-code 700.

At 818, optimizer 304 determines whether interim solution solᵢₙₜ 326 is an improvement over sol_{cur} 324 (i.e., ckt 210 in a first iteration) and satisfies the constraints, for example, as formulated in Eq. (1), based on the corresponding training data-based accuracies 316 and metrics 318 (pseudo-code 700, line 16).

If interim solution solᵢₙₜ 326 is not an improvement over sol_{cur} 324, processing returns to 810, where optimizer 304 selects another pruning opportuning from sorted pruning opportunities pos 308 (i.e., the inner loop continues with the next pruning opportunity).

If interim solution solᵢₙₜ 326 is an improvement over sol/r 324, processing proceeds to 820, where optimizer 304 retains interim solution solᵢₙₜ 326 as a circuit design solution sols 310 and designates interim solution solᵢₙₜ 326 as sol_{cur} 324 (pseudo-code 700, line 17 and 18).

Processing then returns to 806, where optimizer 304 updates pruning opportunities pos 308 based on the prunings applied to the interim solution at 812, and re-sorts updated pruning opportunities pos 308.

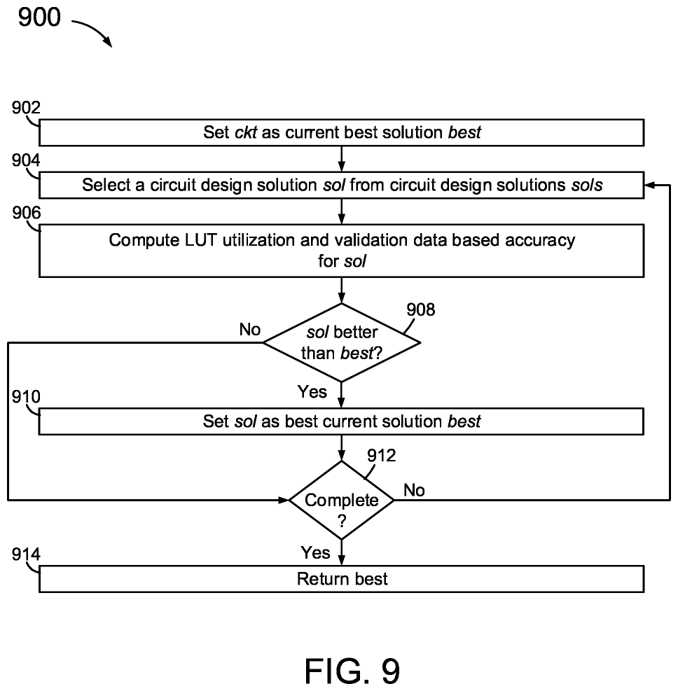

At 822, when pruning opportunities pos 308 are exhausted, processing proceeds to post-processing of circuit design solutions sols 310 (i.e., solutions accepted at 818), such as described further above with reference to 612 in FIG. 6, and/or as described below with reference to FIG. 9.

As described above with respect to FIG. 8, as the circuit structure changes due to pruning, the method updates the sorting and filtering of the pruning opportunities. When a pruning opportunity is rejected, the inner loop continues with the next pruning opportunity. When pruning opportunities are exhausted, the method returns solutions sols 310.

In the example of FIG. 8, if solᵢₙₜ 326 is not an improvement over sol_{cur} 324 (818 in FIG. 8), optimizer 304 essentially rejects the current pruning opportunity and returns to 810 to select another pruning opportunity. Alternatively, optimizer 304 may employ a dynamic, reverse topological order approach, in which optimizer 304 evaluates inputs to the rejected pruning opportunity (e.g., LUTs within a FFC or MFFC of the rejected pruning opportunity). Optimizer 304 may invoke the dynamic reverse topological order approach to evaluate finer-grained pruning opportunities at runtime (i.e., dynamically), in the event that a pruning opportunity of pos 308 is not sufficiently advantageous. The dynamic reverse topological order approach may scale better for larger networks.

In the example of FIG. 8, optimizer 304 employs an iterative greedy approach. Optimizer 304 may utilize one or more of variety heuristics for the iterative greedy approach. Alternatively, or additionally, optimizer 304 may employ one or more other types of optimization/search techniques.

In the example of FIG. 8, pruning at 812 includes ternary-based bit-level pruning. Alternatively, or additionally, optimizer 304 may employ one or more other bit-level pruning techniques, such as, modifying local functions of logic cones (e.g., a FFC and/or a MFFC of a pruning opportunity) based on Boolean Matrix factorization and/or replacement function estimation. Replacement function estimation may include removing an input of a LUT within the cone and consolidating LUTs of the cone (i.e., effectively modifying a function of the cone), to provide interim solution solᵢₙₜ 326, and evaluating solᵢₙₜ 326 relative to sol_{cur} 324 based on corresponding training data-based accuracies 316 and metrics 318, such as described above with reference to 816 in FIG. 8.

FIG. 9 illustrates a flowchart of a method 900 of post-processing bit-level prunings, according to an embodiment. Method 900 may represent an example embodiment of post-processor 306, pseudo-code 400, lines 4-11, and/or post-processing at 612 in FIG. 6.

At 902, post-processor 306 designates ckt 210 as the current best solution best 322 (pseudo-code 400, line 5).

At 904, post-processor 306 retrieves a circuit design solution sol from circuit design solutions so/s 310.

At 906, post-processor 306 computes validation data-based accuracy 320 and metrics 318 for the circuit design solution sol.

At 908, post-processor 306 determines whether the circuit design solution sol meets the constraints and is an improvement over the current best solution best 322 (pseudo-code 400, lines 7 and 8). If circuit design solution sol does not meet the constraints or is not an improvement over best 322, processing returns to 904, where post-processor 306 retrieves another circuit design solution sol from circuit design solutions sols 310. If circuit design solution sol meets the constraints and is an improvement over best 322, processing proceeds to 910, where post-processor 306 sets circuit design solution sol to best 322.

At 912, when all solutions sols 310 have been evaluated, post-processor 306 returns the best 322 as optimized technology-mapped circuit design 214 at 914.

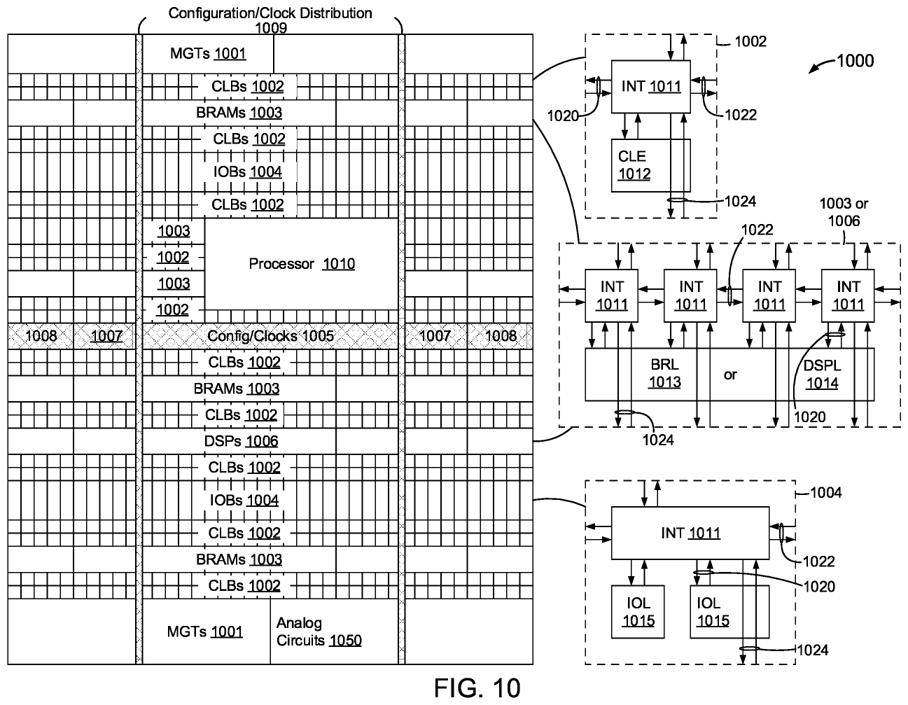

Target platform 206 or a portion thereof, may include one or more of a variety of types of configurable circuit blocks, such as described below with reference to FIG. 10. FIG. 10 is a block diagram of configurable circuitry 1000, including an array of configurable or programmable circuit blocks or tiles, according to an embodiment. The example of FIG. 10 may represent afield programmable gate array (FPGA) and/or other IC device(s) that utilizes configurable interconnect structures for selectively coupling circuitry/logic elements, such as complex programmable logic devices (CPLDs).

In the example of FIG. 10, the tiles include multi-gigabit transceivers (MGTs) 1001, configurable logic blocks (CLBs) 1002, block random access memory (BRAM) 1003, input/output blocks (IOBs) 1004, configuration and clocking logic (Config/Clocks) 1005, digital signal processing (DSP) blocks 1006, specialized input/output blocks (I/O) 1007 (e.g., configuration ports and clock ports), and other programmable logic 1008, which may include, without limitation, digital clock managers, analog-to-digital converters, and/or system monitoring logic. The tiles further include a dedicated processor 1010.

One or more tiles may include a programmable interconnect element (INT) 1011 having connections to input and output terminals 1020 of a programmable logic element within the same tile and/or to one or more other tiles. A programmable INT 1011 may include connections to interconnect segments 1022 of another programmable INT 1011 in the same tile and/or another tile(s). A programmable INT 1011 may include connections to interconnect segments 1024 of general routing resources between logic blocks (not shown). The general routing resources may include routing channels between logic blocks (not shown) including tracks of interconnect segments (e.g., interconnect segments 1024) and switch blocks (not shown) for connecting interconnect segments. Interconnect segments of general routing resources (e.g., interconnect segments 1024) may span one or more logic blocks. Programmable INTs 1011, in combination with general routing resources, may represent a programmable interconnect structure.

A CLB 1002 may include a configurable logic element (CLE) 1012 that can be programmed to implement user logic. A CLB 1002 may also include a programmable INT 1011.

A BRAM 1003 may include a BRAM logic element (BRL) 1013 and one or more programmable INTs 1011. A number of interconnect elements included in a tile may depend on a height of the tile. A BRAM 1003 may, for example, have a height of five CLBs 1002. Other numbers (e.g., four) may also be used.

A DSP block 1006 may include a DSP logic element (DSPL) 1014 in addition to one or more programmable INTs 1011. An IOB 1004 may include, for example, two instances of an input/output logic element (IOL) 1015 in addition to one or more instances of a programmable INT 1011. An I/O pad connected to, for example, an 1/O logic element 1015, is not necessarily confined to an area of the I/O logic element 1015.

In the example of FIG. 10, config/clocks 1005 may be used for configuration, clock, and/or other control logic. Vertical columns 1009 may be used to distribute clocks and/or configuration signals.

A logic block (e.g., programmable or fixed-function) may disrupt a columnar structure of configurable circuitry 1000. For example, processor 1010 spans several columns of CLBs 1002 and BRAMs 1003. Processor 1010 may include one or more of a variety of components such as, without limitation, a single microprocessor to a complete programmable processing system of microprocessor(s), memory controllers, and/or peripherals.

In FIG. 10, configurable circuitry 1000 further includes analog circuits 1050, which may include, without limitation, one or more analog switches, multiplexers, and/or de-multiplexers. Analog switches may be useful to reduce leakage current.

FIG. 10 is provided for illustrative purposes. Configurable circuitry 1000 is not limited to numbers of logic blocks in a row, relative widths of the rows, numbers and orderings of rows, types of logic blocks included in the rows, relative sizes of the logic blocks, illustrated interconnect/logic implementations, or other example features of FIG. 10.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the users computer and partly on a remote computer or entirely on the remote computer or server. In the latter scenario, the remote computer may be connected to the users computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method, comprising:
pruning elements of a current circuit design, at a bit-level, to provide an optimized circuit design; and
selecting one of the current circuit design and the optimized circuit design as a circuit design solution based on one or more of measures of accuracy of the circuit designs, metrics of the circuit designs, and optimization criteria;
wherein the current circuit design and the optimized circuit design comprise technology-mapped circuit designs.

2. The method of claim 1, wherein the elements comprise look-up tables (LUTs) of a network of LUTs, and wherein the metrics comprise measures of LUT utilization.

3. The method of claim 2, wherein the network of LUTs represents a trained artificial neural network, the method further comprising:
selecting a subset of LUTs of the network of LUTs that produce output bits of neurons of the artificial neural network;
wherein the pruning comprises pruning LUTs of the subset.

4. The method of claim 3, further comprising:
ordering the subset of LUTs based on metrics related to cones of the LUTs;
wherein the pruning comprises pruning the LUTs of the subset based on the ordering.

5. The method of claim 4, wherein the metrics related to the cones of the LUTs comprise one or more of:
sizes of maximum fanout-free cones (MFFC) of the LUTs;
sizes of transitive fanin cones of the LUTs;
sizes of transitive fanout cones of the LUTs; and
on/off-times of the output bits represented by the LUTs.

6. The method of claim 3, further comprising one or more of:
discarding LUTs of the subset of LUTs that do not meet a cone size criterion;
discarding LUTs of the subset of LUTs that do not meet a maximum fanout-free cone (MFFC) size criterion;
discarding LUTs of the subset of LUTs do not meet a fanout criterion; and
discarding LUTs of the subset of LUTs that do not meet an optimization criterion.

7. The method of claim 2, wherein the pruning comprises:
selecting a LUT of the current circuit design;
replacing the selected LUT of the current circuit design with a constant logic state to provide a revised circuit design; and
optimizing LUT usage of the revised circuit design to provide the optimized circuit design.

8. The method of claim 7, wherein the optimizing comprises one or more of:
removing LUTs within a maximum fanout-free cone (MFFC) of the replaced LUT; and
optimizing LUT usage downstream of the replaced LUT based on one or more of propagation of the constant logic state and a don't care optimization method.

9. The method of claim 7, further comprising:
pruning inputs to the selected LUT of the current circuit design if the optimized circuit design is not selected as the circuit design solution.

10. The method of claim 7, wherein:
the replacing comprises replacing the selected LUT of the current circuit design with a first constant logic state to provide a first revised circuit design, and replacing the selected LUT of the current circuit design with a second constant logic state to provide a second revised circuit design;
the optimizing comprises optimizing LUT usage of the first and second revised circuit designs; and
the selecting comprises selecting one of the first and second optimized revised circuit designs as an interim circuit design solution based on the measures of accuracy and metrics of the corresponding circuit designs, and selecting one of the interim circuit design solution and the current circuit design as the circuit design solution based on one or more of the measures of accuracy of the corresponding circuit designs, the metrics of the corresponding circuit designs, and optimization criteria.

11. The method of claim 10, wherein the optimizing further comprises one or more of:
removing LUTs of the first and second revised circuit designs within maximum fanout-free cones (MFFCs) of the replaced LUT; and
optimizing LUT usage downstream of the replaced LUT of the first and second revised circuit designs based on one or more of propagation of the corresponding logic states and a don't care optimization method.

12. The method of claim 2, wherein:
the network of LUTs represents a trained artificial neural network;
the measures of accuracy comprise training data-based accuracies of the circuit design and the optimized revised circuit design computed based on training data used to train the artificial neural network; and
the selecting comprises selecting one of the current circuit design and the optimized circuit design as the circuit design solution based on the training data-based accuracies and the metrics of the corresponding circuit designs.

13. The method of claim 12, further comprising post-processing a set of circuit design solutions that includes the circuit design solution, wherein the post-processing comprises:
computing validation data-based accuracies of the circuit design solutions based on validation data used to validate the artificial neural network, wherein the validation data differs from the training data; and
identifying one of the circuit design solutions as an output solution based on the validation data-based accuracies and the metrics of the corresponding circuit designs and an optimization criterion.

14. The method of claim 13, wherein the identifying comprises:
designating a first one of the circuit design solutions as a current best circuit design solution;
evaluating the current best circuit design solution with respect to remaining ones of the circuit design solutions in a pair-wise iterative fashion, wherein each iteration comprises designating one of the current best circuit design solution and a remaining one of the circuit design solutions as the current best circuit design solution based on the validation data-based accuracies and the metrics of the corresponding circuit designs and the optimization criterion; and
identifying the current best circuit design solution as the output solution based on the evaluating.

15. The method of claim 14, further comprising:
discarding one or more of the circuit design solutions for which the validation data-based accuracy is below a baseline accuracy.

16. An apparatus, comprising:
a processor and memory configured to prune a look-up table (LUT) of a network of LUTs of a current circuit design, at a bit-level, to provide a circuit design solution, including to,
replace the LUT with a constant logic state to provide a revised circuit design,
optimize LUT usage of the revised circuit design to provide an optimized circuit design, and
select one of the current circuit design and the optimized circuit design as the circuit design solution based on one or more of measures of accuracy of the corresponding circuit designs, metrics of the corresponding circuit designs, and optimization criteria;
wherein the current circuit design and the optimized circuit design comprise technology-mapped circuit designs.

17. The apparatus of claim 16, wherein the network of LUTs represents a trained artificial neural network, and wherein the processor and memory are further configured to:
select a subset of LUTs of the network of LUTs that produce output bits of neurons of the artificial neural network;
order the subset of LUTs based on metrics related to the corresponding LUTs; and
select the LUT by selecting a highest-ranked LUT of the ordered subset of LUTs.

18. A non-transitory computer readable medium comprising a computer program that comprises instructions to cause a processor to:
prune a look-up table (LUT) of a network of LUTs of a current circuit design, at a bit-level, to provide an optimized circuit design;
select one of the current circuit design and the optimized circuit design as a circuit design solution based on one or more of training data-based accuracies, metrics of the corresponding circuit designs, and optimization criteria; and
evaluate a set of circuit design solutions that includes the circuit design solution, to identify one of the circuit design solutions as an output solution based on validation data-based accuracies and the metrics of the corresponding circuit designs and an optimization criterion;
wherein the current circuit design and the optimized circuit design comprise technology-mapped circuit designs;
wherein the network of LUTs represents a trained artificial neural network;
wherein the training data-based accuracies are based on training data used to train the artificial neural network; and
wherein the validation data-based accuracies are based on validation data used to validate the artificial neural network.

19. The non-transitory computer readable medium of claim 18, further comprising instructions to cause the processor to:
select a subset of LUTs of the network of LUTs that produce output bits of neurons of the artificial neural network;
order the subset of LUTs based on metrics related to the corresponding LUTs; and
select the LUT from the subset of LUTs based on the ordering of the subset of LUTs.

20. The non-transitory computer readable medium of claim 17, further comprising instructions to cause the processor to prune the LUT by:
replacing the LUT with a constant logic state to provide a revised circuit design; and
optimizing LUT usage of the revised circuit design to provide the optimized circuit design.
